(19) United States
(12) Patent Application Publication
(10) Pub. No.: US 2006/0101788 A1
(43) Pub. Date: May 18, 2006

(54) Device for screwing screw caps, the device including a mechanically-controlled gripper clamp

(75) Inventor: Andre Graffin, Kuala Lumpur (MY)

Correspondence Address: BIRCH STEWART KOLASCH & BIRCH, PO BOX 747, FALLS CHURCH, VA, 22040-0747, US

(73) Assignee: SERAC GROUP

(21) Appl. No.: 11/264,019

(22) Filed: Nov. 2, 2005

(30) Foreign Application Priority Data
Nov. 18, 2004 (FR) 04 12237

(51) Int. Cl. B67B 3/20

(52) U.S. Cl. 53/317

(57) ABSTRACT

The present invention relates to a device for screwing caps onto receptacles, the device comprising at least one screwing spindle mounted to rotate on a support element, the spindle being provided with a cap-gripping clamp and slidably receiving a control element possessing one end connected to the clamp and an opposite end connected to a displacement member, the device comprising: a toggle-action connection interconnecting the support member and the control element, and possessing a first stable position holding the control element in a clamp-open position and a second stable position holding the control element in a clamp-closed position; and moving means for moving the connection into its stable position.

The present invention relates to a device for screwing caps onto receptacles.

### BACKGROUND OF THE INVENTION

Such a screwing device comprises a stationary frame having pivotally mounted thereon a platform provided with rotary screwing spindle. Each spindle is provided with a cap-gripping clamp and slidably receives a clamp-control element. The control element has one end connected to the clamp and an opposite end associated with a displacement member for moving the control element between a clamp-open position and a clamp-closed position. The displacement member is generally constituted by an electromagnet coil secured to the support element. Because the support element revolves relative to the stationary frame, the electrical power supply to the coil is relatively complex and is made in particular by using rubbing contacts that are subjected to relatively high levels of wear and clogging.

### OBJECT OF THE INVENTION

It would therefore be advantageous to have means for actuating the clamp that do not require an electrical power supply of the above-mentioned type.

### BRIEF DESCRIPTION OF THE INVENTION

To this end, the invention provides a device for screwing caps onto receptacles, the device comprising at least one screwing spindle mounted to rotate on a support element, the spindle being provided with a clamp for gripping caps and slidably receiving a control element possessing one end connected to the clamp and an opposite end connected to a displacement member for displacing the control element between an open position and a closed position of the clamp, the displacement member comprising:

a toggle-action connection interconnecting the support member and the control element and possessing a first stable position for holding the control element in an open position and a second stable position for holding the control element in a closed position; and

moving means for moving for bringing the connection into its stable position.

Thus, the member for displacing the control element holds the control element in its open position and in its closed position by a connection operating with a toggle action. The toggle-action connection ensures that the control element is positively held in its two positions. The control element is therefore held in its open position and in its closed position without requiring any electrical power supply.

Preferably, the spindle is associated with an indicator of the presence of a cap in the clamp, the indicator comprising a rod mounted to slide in the control element between a cap-absent position and a cap-present position, the rod being arranged, in the cap-present position, to move the toggle-action connection from its first stable position to a third stable position for holding the clamp in a position of intermediate tightness, the third stable position being situated between the first stable position and the second stable position.

Thus, as soon as a cap is detected in the clamp, the clamp is moved by the toggle-action connection into a cap-engaging position before maximum clamping is applied to the cap at the beginning of screw tightening.

Other characteristics and advantages of the invention appear on reading the following description of a particular and non-limiting embodiment of the invention.

### BRIEF DESCRIPTION OF THE DRAWINGS

Reference is made to the accompanying drawings, in which:

FIG. 1 is a fragmentary view, partially in section, showing a screwing device in accordance with the invention, and showing more particularly a spindle with a clamp in the closed position and a displacement member in its second stable position;

FIG. 2 is a view showing a detail of FIG. 1 for the clamp in the open position, the displacement member being in its first stable position;

FIG. 3 is a detail view of FIG. 1 for the clamp in an intermediate position, the displacement member being in its third stable position;

FIG. 4 is a fragmentary perspective view of the screwing device showing the displacement member being locked in its second stable position;

FIG. 5 is a fragmentary perspective view of the screwing device showing the displacement member being unlocked from its second stable position; and

FIG. 6 is a fragmentary perspective view of the screwing device showing the displacement member in its first stable position.

### DETAILED DESCRIPTION OF THE INVENTION

With reference to the figures, the screwing device in accordance with the invention comprises a stationary frame 1 provided with a stationary toothed annulus 2 and a platform 3 of known type mounted on the stationary frame 1 to revolve about the stationary annulus 2.

The platform 3 is fitted with support elements 4 mounted in conventional manner to slide parallel to the axis of rotation of the platform 3.

Screwing spindles, given overall reference 5 are mounted to rotate on the support elements 4 (only one spindle is visible in the figures). Each screwing spindle 5 comprises a top half-spindle 6 with a top end provided with a gearwheel 7 meshing with the toothed ring 2, and a bottom end connected via a torque limiter 8, of known type, to a top end of a bottom half-spindle 9 having a bottom end that is provided with a clamp given overall reference 10.

The clamp 10 is itself conventional, comprising an outer bell 11 receiving jaws 12 of frustoconical outside surface for co-operating with a frustoconical inside surface of an inner bell 13 that is axially slidable in the outer bell 11 between a low position in which the jaws 12 are pressed together, the clamp 10 then being in the closed position, and a high position in which the jaws 12 are spaced apart, the clamp 10 then being in the open position. Springs 14 extend circumferentially between the jaws 12 and tend to space them apart from one another.

The inner bell 13 is connected at a bottom end to a tubular control element 15 which is slidably received in the spindle 5 and possesses a top end projecting from the screwing spindle 5.

A ring 16 is secured to the top end of the control element 15 and co-operates with a displacement member for moving the control element 15 between the high and low positions of the inner bell 13, corresponding to the clamp 10 being in the open and closed positions.

The displacement member, given overall reference 17, includes a toggle-action connection given overall reference 18.

The toggle-action connection 18 comprises a pivot portion 19 mounted on the support element 4 to pivot about an axis that is substantially perpendicular to the sliding direction of the control element 15, and a connecting rod 20 having one end 20.1 hinged eccentrically to the pivot portion 19, and an opposite end 20.2 hinged to the control element 15 via a lever 21.

In this example, the lever 21 is rectangular, having one end 22 hinged to the support element 4 and an opposite end 23 hinged to the end 20.2 of the connecting rod 20. The lever 21 has an intermediate portion connected to an axial ball abutment 24 bearing via a compressible resilient element 25 against the ring 16 fixed to the top end of the control element 15. The axial abutment 24 is mounted on the lever 21 to oscillate about an axis parallel to the hinge axis between the lever 21 and the support element 4.

The displacement member 17 includes a compression spring 26 having one end 27 hinged to a pin 28 secured eccentrically to the pivot portion 19, and an opposite end 29 bearing against the support element 4.

The toggle-action connection 18 thus possesses three stable positions.

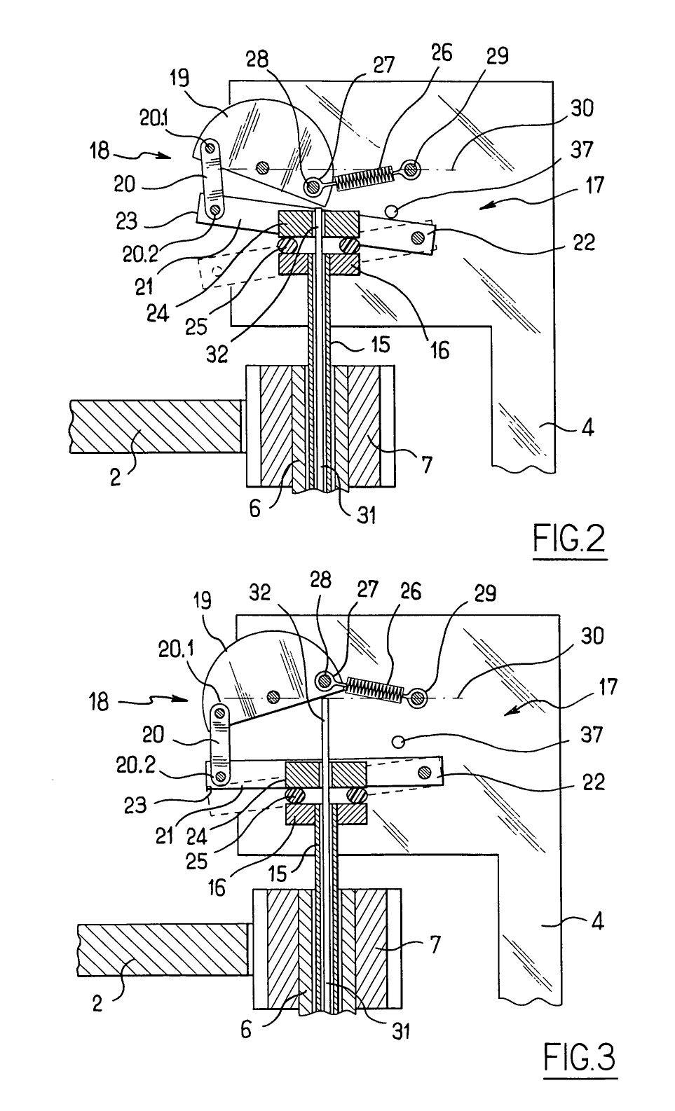

In a first stable position, shown in FIG. 2, the toggle-action connection 18 pulls the end 23 of the lever 21 upwards so that the control element 15 is pushed towards the high position under the action of the springs 14 moving the jaws 12 apart and pushing the inner bell 13 towards the high position. A spring may also be interposed between the gearwheel 7 and the ring 16 to improve the return of the control element 15 towards the high position. The lever 21 presses against an abutment 37 secured to the support element 4. The clamp 10 is in the open position. The end 27 of the spring 26 is situated under a line 30 joining the pivot axis of the pivot portion 19 to the end 29 of the spring 26. This line represents the ends of the spring 27 and the pivot axis of the pivot portion 19 being in alignment when the pivot portion 19 is in a position in which it applies maximum compression to the spring 26.

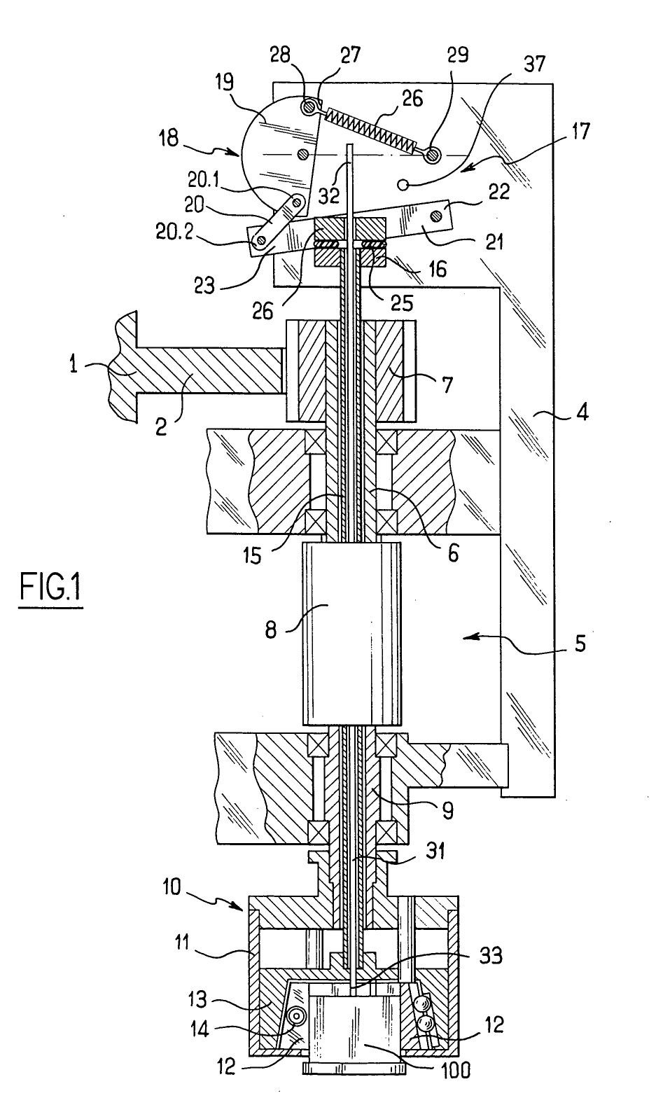

In a second stable position, as shown in FIG. 1, the toggle-action connection 18 pushes the end 23 of the lever 21 downwards so that the control element 15 is pushed towards the low position, thereby compressing the resilient element 25. The clamp 10 is in the closed position. To reach the second stable position, it is necessary for the pivot portion 19 to pivot beyond the position in which the ends 20.1 and 20.2 of the connecting rod 20 and the pivot axis of the pivot portion 19 are in alignment (when these three points are in alignment, the pivot portion 19 is in a position of maximum compression on the resilient element 25).

In a third stable position, shown in FIG. 3, the toggle-action connection 18 pushes the end 23 of the lever 21 downwards so that the control element 15 is pushed downwards, but not sufficiently to flatten the resilient element 25 and bring the control element into the low position. The clamp 10 is in a position of intermediate tightness. The end 27 of the spring 26 is situated above the line 30 and the position in which the ends 20.1 and 20.2 of the connecting rod 20 and the pivot axis of the pivot portion 19 are in alignment has not been exceeded.

It will be understood that during pivoting of the pivot portion 19, hard points are encountered on passing through the position of maximum compression of the spring 26 and the position of the maximum compression of the resilient element 25 (where these positions are unstable positions).

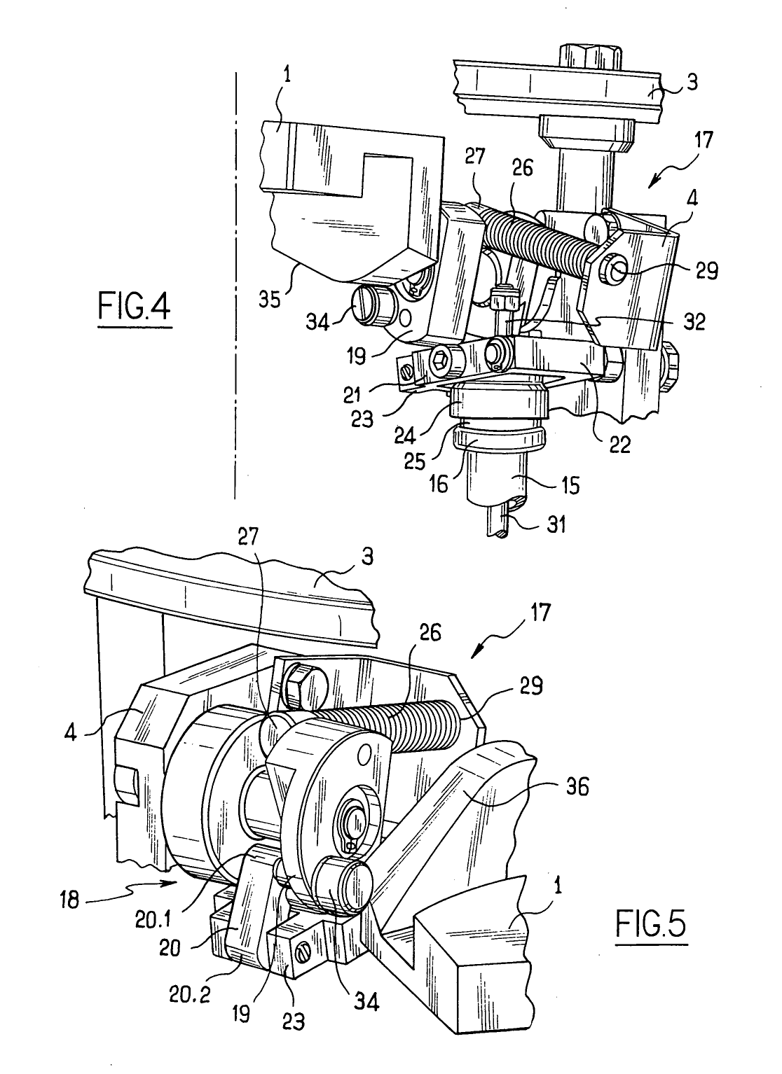

A wheel 34 (visible in FIGS. 4 to 6) is secured to the pivot portion 19 to co-operate with a cam surface 35 secured to the stationary frame 1 in order to bring the toggle-action connection 18 from its third stable position to its second stable position, and with a cam surface 36 (visible in FIG. 5) secured to the stationary frame 1 to bring the toggle-action connection 18 from its second stable position to its first stable position.

Each screwing spindle 5 is associated in conventional manner with an indicator for indicating the presence of a cap in the clamp 10. The indicator comprises a rod 31 received in the control element 15 and possessing an end 33 projecting into the inner bell 13 of the clamp 10, and an end 32 projecting from the axial abutment 24. The rod 31 is mounted to slide in the control element 15 between a low position when there is no cap and a high position when a cap is present, the rod 31 being arranged, in the cap-present position, to move the toggle-action connection 18 from its first stable position to its third stable position.

A screwing cycle of a spindle 5 is described below without mentioning the rotary movement of the spindle or the down and up movements of the support element 4 which are implemented in conventional manner to engage the cap on the neck of the receptacle so that it can be screwed onto the receptacle, and to disengage the clamp 10 from the receptacle at the end of screw-tightening in order to be able to remove the receptacle.

The platform 3 revolves relative to the stationary frame 1.

At the beginning of the screwing cycle, the clamp 10 is in the open position, the rod 31 is in the cap-absent position, and the toggle-action connection is in its first stable position (FIG. 2).

When a cap 100 is brought into the clamp 10, the rod 31 is pushed back by the cap towards the cap-present position (FIG. 3). The end 32 then comes into contact with the end 27 of the spring 26 and pushes said end above the line 30, causing the pivot portion 19 to pivot. Once the end 27 has passed above the line 30, the spring 26 relaxes and brings the toggle-action connection 18 into its third stable position. It should be observed that the force exerted by the spring 26 is too weak to compress the resilient element 25 sufficiently to cause the pivot portion 19 to pass beyond the position of maximum compression of the resilient element 25. The control element 15 is pushed downwards, bringing the clamp 10 into its position of intermediate tightness ensuring that it keeps hold of the cap 100.

As rotation of the platform 3 continues, the wheel 34 encounters the cam surface 35 which causes the pivot portion 19 to pivot beyond the position of maximum compression of the resilient element 25 so as to bring the toggle-action connection 18 from its third stable position to its second stable position (FIGS. 1 and 4). The clamp 10 is in the closed position and the cap 100 is held with maximum tightness during the screwing operation.

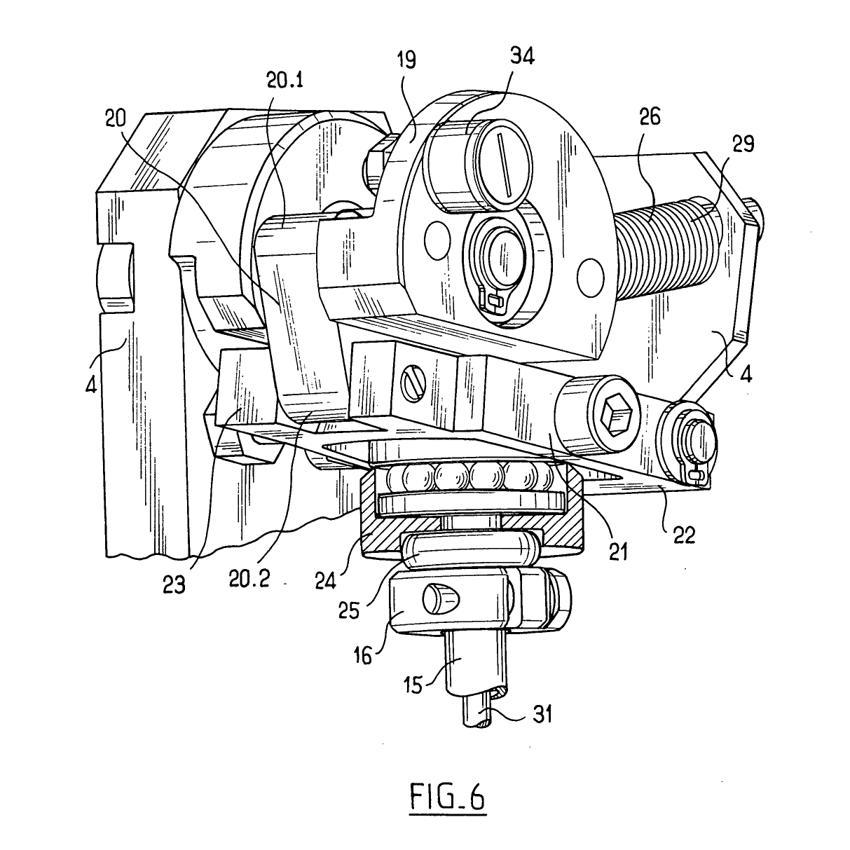

Once screwing has been completed, the wheel 34 encounters the cam surface 36 (FIG. 5) causing the pivot portion 19 to pivot beyond the position of maximum compression of the spring 26 to bring the toggle-action connection 18 from its second stable position to its first stable position (FIGS. 6 and 2). The spring 26 holds the toggle-action connection 18 in its first position. The clamp 10 is then in its open position and the spindle is ready for a new screwing cycle.

Naturally, the invention is not limited to the embodiment described above but covers any variant coming within the ambit of the invention as defined by the claims.

The toggle-action connection can thus have a structure that is different from that described, for example it could comprise a pivot portion forming a cam and bearing directly against the end 22 of the lever 21.

The toggle-action connection may also have only two stable positions for holding the clamp respectively in the closed position and in the open position.

The lever 21 is optional and the connecting rod 20 could be connected directly to the control element 15.

What is claimed is:

1. A device for screwing caps onto receptacles, the device comprising at least one screwing spindle mounted to rotate on a support element, the spindle being provided with a clamp for gripping caps and slidably receiving a control element possessing one end connected to the clamp and an opposite end connected to a displacement member for displacing the control element between an open position and a closed position of the clamp, wherein the displacement member comprises:
a toggle-action connection interconnecting the support member and the control element and possessing a first stable position for holding the control element in an open position and a second stable position for holding the control element in a closed position; and
moving means for moving for bringing the connection into its stable position.

2. A screwing device according to claim 1, wherein the spindle is associated with an indicator of the presence of a cap in the clamp, the indicator comprising a rod mounted to slide in the control element between a cap-absent position and a cap-present position, the rod being arranged, in the cap-present position, to move the toggle-action connection from its first stable position to a third stable position for holding the clamp in a position of intermediate tightness, the third stable position being situated between the first stable position and the second stable position.

3. A screwing device according to claim 1, wherein the toggle-action connection comprises a pivot portion mounted on the support element and a connecting rod having a first end hinged to the control element and a second end hinged eccentrically to the pivot portion.

4. A screwing device according to claim 3, wherein the first end of the connecting rod is connected to a first end of a lever having a second end hinged to the support element and an intermediate portion hinged to the control element.

5. A screwing device according to claim 4, wherein a compressible resilient element is interposed between the lever and the control element.

6. A screwing device according to claim 3, wherein the moving means compress a compression spring having one end connected eccentrically to the pivot portion and one end connected to the support element.

7. A screwing device according to claim 1, wherein the support element is mounted to pivot on a stationary frame, and wherein the moving means comprise at least one cam surface secured to the stationary frame and a wheel secured to the toggle-action connection in such a manner as to run on the cam surface.

8. A screwing device according to claim 1, wherein the moving means include a resilient return member for returning the toggle-action connection towards the first stable position.
